(19) United States
(12) Patent Application Publication
(10) Pub. No.: US 2015/0245223 A1
(43) Pub. Date: Aug. 27, 2015

(54) WEIGHTED SUMMING AND RADIO FREQUENCY (RF) PATH SELECTION FOR MULTIPLE ANTENNA SYSTEMS USING SENSORS AND RECEIVED SIGNAL LEVEL

(71) Applicant: QUALCOMM Incorporated, San Diego, CA (US)

(72) Inventor: In-Sung PARK, Seoul (KR)

(73) Assignee: QUALCOMM INCORPORATED, San Diego, CA (US)

(21) Appl. No.: 14/186,846

(22) Filed: Feb. 21, 2014

(51) Int. Cl. H04W 24/02; H04W 52/02

(52) U.S. Cl. CPC H04W 24/02; H04W 52/0206; H04W 24/08

(57) ABSTRACT

Methods and apparatus are provided for intelligently enabling or disabling radio frequency (RF) paths in a wireless device. This may save power, for example, in situations where an RF path may not be contributing to antenna gain, but may still be drawing power from the device. One example method generally includes measuring received signal levels for a plurality of RF paths in an apparatus; powering off at least a portion of an RF path in the plurality if a received signal level of the RF path does not meet or exceed a threshold; after powering off the at least the portion of the RF path, determining that a signal blocking aspect affecting the RF path has been removed or at least reduced, without powering on the powered-off portion of the RF path for the determination; and powering on the powered-off portion of the RF path based on the determination.

### TECHNICAL FIELD

Certain aspects of the present disclosure generally relate to wireless communications and, more particularly, to intelligently enabling or disabling radio frequency (RF) chains and performing weighted summing of received signals, based on received signal levels and sensor measurements of signal blocking aspects for the RF chains.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. For example, one network may be a 3G (the third generation of mobile phone standards and technology) system, which may provide network service via any one of various 3G radio access technologies (RATs) including EVDO (Evolution-Data Optimized), 1×RTT (1 times Radio Transmission Technology, or simply 1×), W-CDMA (Wideband Code Division Multiple Access), UMTS-TDD (Universal Mobile Telecommunications System-Time Division Duplexing), HSPA (High Speed Packet Access), GPRS (General Packet Radio Service), or EDGE (Enhanced Data rates for Global Evolution). The 3G network is a wide area cellular telephone network that evolved to incorporate high-speed internet access and video telephony, in addition to voice calls. Furthermore, a 3G network may be more established and provide larger coverage areas than other network systems. Such multiple access networks may also include code division multiple access (CDMA) systems, time division multiple access (TDMA) systems, frequency division multiple access (FDMA) systems, orthogonal frequency division multiple access (OFDMA) systems, single-carrier FDMA (SC-FDMA) networks, 3rd Generation Partnership Project (3GPP) Long Term Evolution (LTE) networks, and Long Term Evolution Advanced (LTE-A) networks.

A wireless communication network may include a number of base stations that can support communication for a number of mobile stations. A mobile station (MS) may communicate with a base station (BS) via a downlink and an uplink. The downlink (or forward link) refers to the communication link from the base station to the mobile station, and the uplink (or reverse link) refers to the communication link from the mobile station to the base station. A base station may transmit data and control information on the downlink to a mobile station and/or may receive data and control information on the uplink from the mobile station.

### SUMMARY

Certain aspects of the present disclosure generally relate to intelligently enabling or disabling radio frequency (RF) paths (i.e., RF chains) using sensors and received signal levels for the RF paths in an effort to save power in wireless communication devices.

Certain aspects of the present disclosure provide a method for wireless communications. The method generally includes measuring received signal levels for a plurality of RF paths in an apparatus; powering off at least a portion of an RF path in the plurality if a received signal level of the RF path does not meet or exceed a threshold; after powering off the at least the portion of the RF path, determining that a signal blocking aspect affecting the RF path has been removed or at least reduced, without powering on the powered-off portion of the RF path based on the determination; and powering on the powered-off portion of the RF path based on the determination.

Certain aspects of the present disclosure provide an apparatus for wireless communications. The apparatus includes a plurality of RF paths and a processing system. The processing system is generally configured to measure received signal levels for the plurality of RF paths; to power off at least a portion of an RF path in the plurality if a received signal level of the RF path does not meet or exceed a threshold; to determine, after powering off the at least the portion of the RF path, that a signal blocking aspect affecting the RF path has been removed or at least reduced, without powering on the powered-off portion of the RF path for the determination; and to power on the powered-off portion of the RF path based on the determination.

Certain aspects of the present disclosure provide an apparatus for wireless communications. The apparatus generally includes means for measuring received signal levels for a plurality of RF paths; means for powering off at least a portion of an RF path in the plurality if a received signal level of the RF path does not meet or exceed a threshold; means for determining, after powering off the at least the portion of the RF path, that a signal blocking aspect affecting the RF path has been removed or at least reduced, without powering on the powered-off portion of the RF path for the determination; and means for powering on the powered-off portion of the RF path based on the determination.

Certain aspects of the present disclosure provide a computer program product for wireless communications. The computer program product generally includes a computer-readable medium having instructions executable to measure received signal levels for a plurality of RF paths in an apparatus; to power off at least a portion of an RF path in the plurality if a received signal level of the RF path does not meet or exceed a threshold; to determine, after powering off the at least the portion of the RF path, that a signal blocking aspect affecting the RF path has been removed or at least reduced, without powering on the powered-off portion of the RF path for the determination; and to power on the powered-off portion of the RF path based on the determination.

Certain aspects of the present disclosure generally relate to performing weighted combining of received signals for a plurality of RF paths, using sensors and received signal levels for the RF paths.

Certain aspects of the present disclosure provide a method for wireless communications. The method generally includes measuring received signal levels for a plurality of RF paths in an apparatus, measuring signal blocking aspects of the plurality of RF paths using a plurality of proximity sensors, and performing a weighted combination of signals received by the RF paths in an antenna diversity scheme based on the measured received signal levels and on the measured signal blocking aspects.

Certain aspects of the present disclosure provide an apparatus for wireless communications. The apparatus includes a plurality of RF paths and a processing system. The processing system is generally configured to measure received signal levels for the plurality of RF paths, to measure signal blocking aspects of the plurality of RF paths using a plurality of proximity sensors, and to perform a weighted combination of signals received by the RF paths in an antenna diversity scheme based on the measured received signal levels and on the measured signal blocking aspects.

Certain aspects of the present disclosure provide an apparatus for wireless communications. The apparatus generally includes means for measuring received signal levels for a plurality of RF paths in the apparatus, means for measuring signal blocking aspects of the plurality of RF paths using a plurality of proximity sensors, and means for performing a weighted combination of signals received by the RF paths in an antenna diversity scheme based on the measured received signal levels and on the measured signal blocking aspects.

Certain aspects of the present disclosure provide a computer program product for wireless communications. The computer program product generally includes a computer-readable medium having instructions executable to measure received signal levels for a plurality of RF paths in an apparatus, to measure signal blocking aspects of the plurality of RF paths using a plurality of proximity sensors, and to perform a weighted combination of signals received by the RF paths in an antenna diversity scheme based on the measured received signal levels and on the measured signal blocking aspects.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network in accordance with certain aspects of the present disclosure.

FIG. 2 is a block diagram of an example access point (AP) and example user terminals in accordance with certain aspects of the present disclosure.

FIGS. 3A-3B illustrate example wireless devices having sensors on opposite sides of the devices, in accordance with certain aspects of the present disclosure.

FIG. 4 is a block diagram of an example wireless device having multiple sensors and radio frequency (RF) paths in accordance with certain aspects of the present disclosure.

FIG. 5 illustrates one of the RF chains in FIG. 4 being disabled, in accordance with certain aspects of the present disclosure.

FIG. 6 is a flow diagram of an example method for intelligently enabling or disabling RF paths, in accordance with certain aspects of the present disclosure.

FIG. 7 is a flow diagram of an example method for combining signals received by RF paths in an antenna diversity scheme, in accordance with certain aspects of the present disclosure.

### DETAILED DESCRIPTION

Certain aspects of the present disclosure provide mechanisms for intelligently enabling and disabling radio frequency (RF) chains in a wireless device. RF chains may be intelligently enabled or disabled to provide for power savings, for example, in weak signal situations where an RF chain may not be contributing to antenna gain, but may be drawing power from the wireless device. Certain other aspects of the present disclosure involve performing a weighted combination of signals received by the RF chains in an antenna diversity scheme based on measured received signal levels and on measured signal blocking aspects.

Various aspects of the present disclosure are described below. It should be apparent that the teachings herein may be embodied in a wide variety of forms and that any specific structure, function, or both being disclosed herein is merely representative. Based on the teachings herein, one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

The word “exemplary” is used herein to mean “serving as an example, instance, or illustration.” Any aspect described herein as “exemplary” is not necessarily to be construed as preferred or advantageous over other aspects.

The techniques described herein may be used in combination with various wireless technologies such as Code Division Multiple Access (CDMA), Orthogonal Frequency Division Multiplexing (OFDM), Time Division Multiple Access (TDMA), Spatial Division Multiple Access (SDMA), Single Carrier Frequency Division Multiple Access (SC-FDMA), Time Division Synchronous Code Division Multiple Access (TD-SCDMA), and so on. Multiple user terminals can concurrently transmit/receive data via different (1) orthogonal code channels for CDMA, (2) time slots for TDMA, or (3) sub-bands for OFDM. A CDMA system may implement IS-2000, IS-95, IS-856, Wideband-CDMA (W-CDMA), or some other standards. An OFDM system may implement Institute of Electrical and Electronics Engineers (IEEE) 802.11, IEEE 802.16, Long Term Evolution (LTE) (e.g., in TDD and/or FDD modes), or some other standards. A TDMA system may implement GSM or some other standards. These various standards are known in the art.

### An Example Wireless System

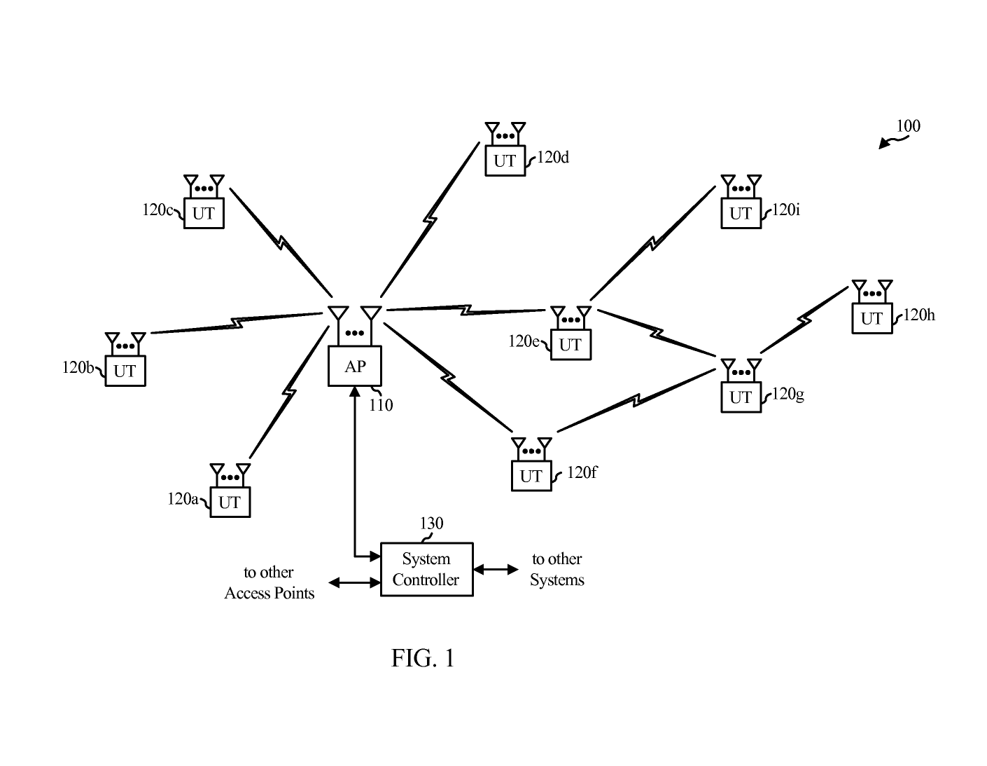

FIG. 1 illustrates a wireless communications system 100 with access points and user terminals. For simplicity, only one access point 110 is shown in FIG. 1. An access point (AP) is generally a fixed station that communicates with the user terminals and may also be referred to as a base station (BS), an evolved Node B (eNB), or some other terminology. A user terminal (UT) may be fixed or mobile and may also be referred to as a mobile station (MS), an access terminal, user equipment (UE), a station (STA), a client, a wireless device, or some other terminology. A user terminal may be a wireless device, such as a cellular phone, a personal digital assistant (PDA), a handheld device, a wireless modem, a laptop computer, a tablet, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

System 100 employs multiple transmit and multiple receive antennas for data transmission on the downlink and uplink. Access point 110 may be equipped with a number Nₐₚ of antennas to achieve transmit diversity for downlink transmissions and/or receive diversity for uplink transmissions. A set Nᵤ of selected user terminals 120 may receive downlink transmissions and transmit uplink transmissions. Each selected user terminal transmits user-specific data to and/or receives user-specific data from the access point. In general, each selected user terminal may be equipped with one or multiple antennas (i.e., Nᵤₜ≧1). The Nᵤ selected user terminals can have the same or different number of antennas.

Wireless system 100 may be a time division duplex (TDD) system or a frequency division duplex (FDD) system. For a TDD system, the downlink and uplink share the same frequency band. For an FDD system, the downlink and uplink use different frequency bands. System 100 may also utilize a single carrier or multiple carriers for transmission. Each user terminal may be equipped with a single antenna (e.g., in order to keep costs down) or multiple antennas (e.g., where the additional cost can be supported).

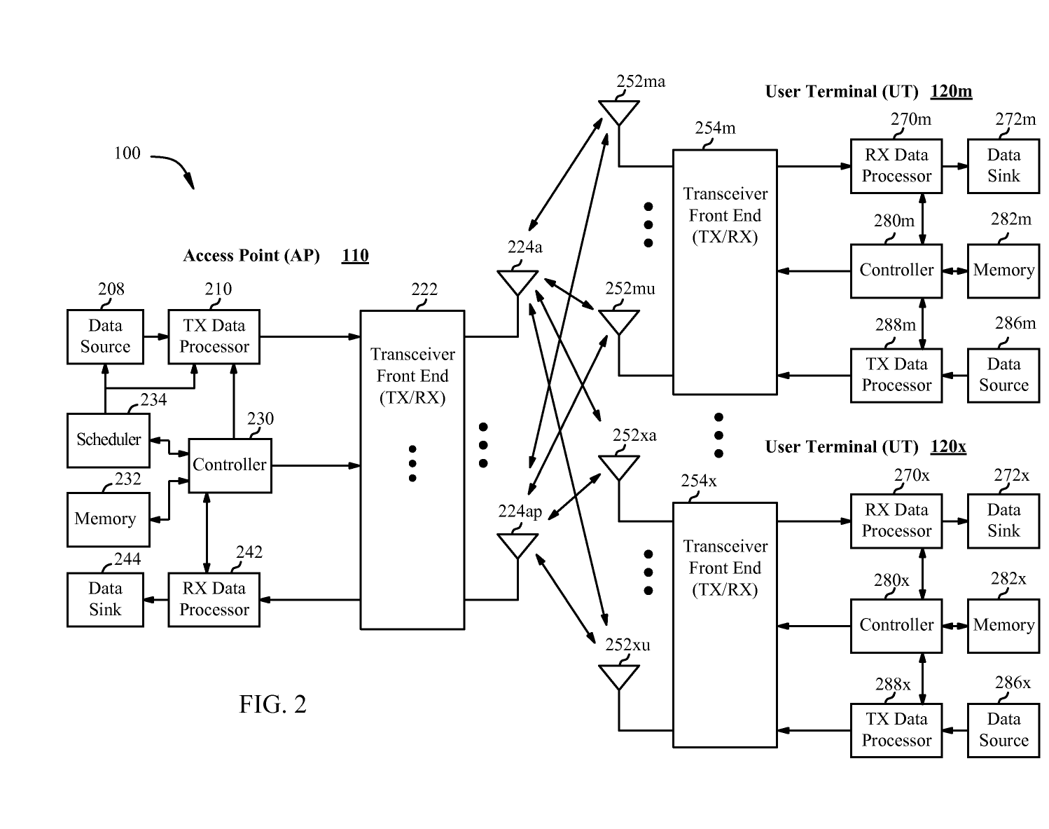

FIG. 2 shows a block diagram of access point 110 and two user terminals 120m and 120x in wireless system 100. Access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. Access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. Beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data {dᵤₚ} for the user terminal based on the coding and modulation schemes associated with the rate selected for the user terminal and provides a data symbol stream {sᵤₚ} for one of the N_{ut,m} antennas. A transceiver front end (TX/RX) 254 (also known as a radio frequency front end (RFFE)) receives and processes (e.g., converts to analog, amplifies, filters, and frequency upconverts) a respective symbol stream to generate an uplink signal. The transceiver front end 254 may also route the uplink signal to one of the N_{ut,m} antennas for transmit diversity via an RF switch, for example. The controller 280 may control the routing within the transceiver front end 254.

A number Nᵤₚ of user terminals may be scheduled for simultaneous transmission on the uplink. Each of these user terminals transmits its set of processed symbol streams on the uplink to the access point.

At access point 110, Nₐₚ antennas 224a through 224ap receive the uplink signals from all Nᵤₚ user terminals transmitting on the uplink. For receive diversity, a transceiver front end 222 may select signals received from one of the antennas 224 for processing. For certain aspects of the present disclosure, a combination of the signals received from multiple antennas 224 may be combined for enhanced receive diversity. The access point's transceiver front end 222 also performs processing complementary to that performed by the user terminal's transceiver front end 254 and provides a recovered uplink data symbol stream. The recovered uplink data symbol stream is an estimate of a data symbol stream {sᵤₚ} transmitted by a user terminal An RX data processor 242 processes (e.g., demodulates, deinterleaves, and decodes) the recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230 and possibly other data from a scheduler 234. The various types of data may be sent on different transport channels. TX data processor 210 processes (e.g., encodes, interleaves, and modulates) the traffic data for each user terminal based on the rate selected for that user terminal TX data processor 210 may provide a downlink data symbol streams for one of more of the N_{dn} user terminals to be transmitted from one of the Nₐₚ antennas. The transceiver front end 222 receives and processes (e.g., converts to analog, amplifies, filters, and frequency upconverts) the symbol stream to generate a downlink signal. The transceiver front end 222 may also route the downlink signal to one or more of the Nₐₚ antennas 224 for transmit diversity via an RF switch, for example. The controller 230 may control the routing within the transceiver front end 222.

At each user terminal 120, N_{ut,m} antennas 252 receive the downlink signals from access point 110. For receive diversity at the user terminal 120, the transceiver front end 254 may select signals received from one of the antennas 252 for processing. For certain aspects of the present disclosure, a combination of the signals received from multiple antennas 252 may be combined for enhanced receive diversity. The user terminal's transceiver front end 254 also performs processing complementary to that performed by the access point's transceiver front end 222 and provides a recovered downlink data symbol stream. An RX data processor 270 processes (e.g., demodulates, deinterleaves, and decodes) the recovered downlink data symbol stream to obtain decoded data for the user terminal.

Those skilled in the art will recognize the techniques described herein may be generally applied in systems utilizing any type of multiple access schemes, such as TDMA, SDMA, Orthogonal Frequency Division Multiple Access (OFDMA), CDMA, SC-FDMA, and combinations thereof.

### Example RF Path Selection and Weighted Summing for Multiple Antenna Devices

In a wireless communication system (e.g., system 100), multiple antennas may be used, for example, to obtain diversity gain or support multiple-input, multiple-output (MIMO) communications. The performance of an antenna, however, may be degraded due to the hand/body effect (i.e., hand-effect body loss). In addition, some wireless communication systems may use different (non-equivalent) antennas for the primary antenna and the diversity antenna, which may result in the diversity RF path experiencing more antenna gain degradation than the primary RF path. This degradation may be more critical in a weak signal area, where some RF paths may not contribute to getting enough antenna gain, but are still consuming power.

According to certain aspects, RF paths that do not meet or exceed a threshold receive signal level (or a combination of the received signal level and a signal blocking quantity) may be powered off in an effort to save power. The received signal level may be, for example, a carrier-to-noise ratio (C/N) or a received signal strength indicator (RSSI). Proximity sensors (e.g., capacitive touch sensors) may be used to determine the signal blocking quantity due to, for example, the hand-body effect. The proximity sensors may be placed adjacent to antennas for the RF paths in an effort to sense gain degradation (i.e., degradation of reception efficiency) for each antenna.

Once the RF path is powered off, it is difficult to measure a received signal level with this RF path to know if the path should be powered on (e.g., due to the signal blocking phenomenon being removed, or at least reduced in quantity). Therefore, the proximity sensors may be used to determine reduction of the signal blocking aspect. Once the signal blocking aspect has been removed or reduced below a particular threshold as sensed by a particular proximity sensor, then the RF path associated with this particular sensor may be powered on once again.

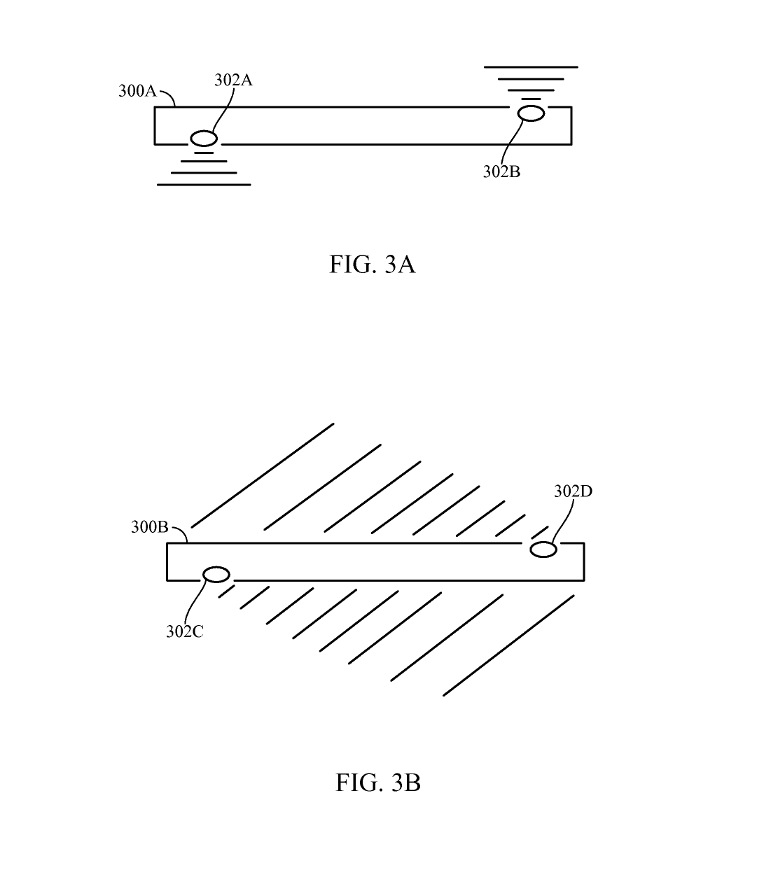

FIGS. 3A and 3B illustrate example wireless devices 300 that may have proximity sensors 302 for determining signal blocking quantities caused by, for example, the hand/body effect. The wireless device 300 may have one or more proximity sensors 302, each of which may be disposed on or near a surface of the device and located adjacent an antenna (not shown). In one example embodiment, wireless device 300A may have proximity sensors 302A and 302B positioned on different surfaces of the device. For example, sensor 302A may be placed on the front side of device 300A, and sensor 302B may be placed on the back side of the device (i.e., with sensors 302A and 302B on opposite sides of the device 300A). The proximity sensors 302A and 302B may be configured for sensing perpendicular to the surface of the device 300A, as illustrated in FIG. 3A. This may provide somewhat limited coverage of the device's surface. In another example embodiment illustrated in FIG. 3B, the proximity sensors 302C and 302D may be configured for sensing at an angle with respect to the wireless device 300B, such that a single sensor may be used to effectively cover a larger surface area of the device. The proximity sensors 302 may be configured to have any of various suitable detection ranges and sensitivities. The number of proximity sensors may vary depending on the number of RF chains.

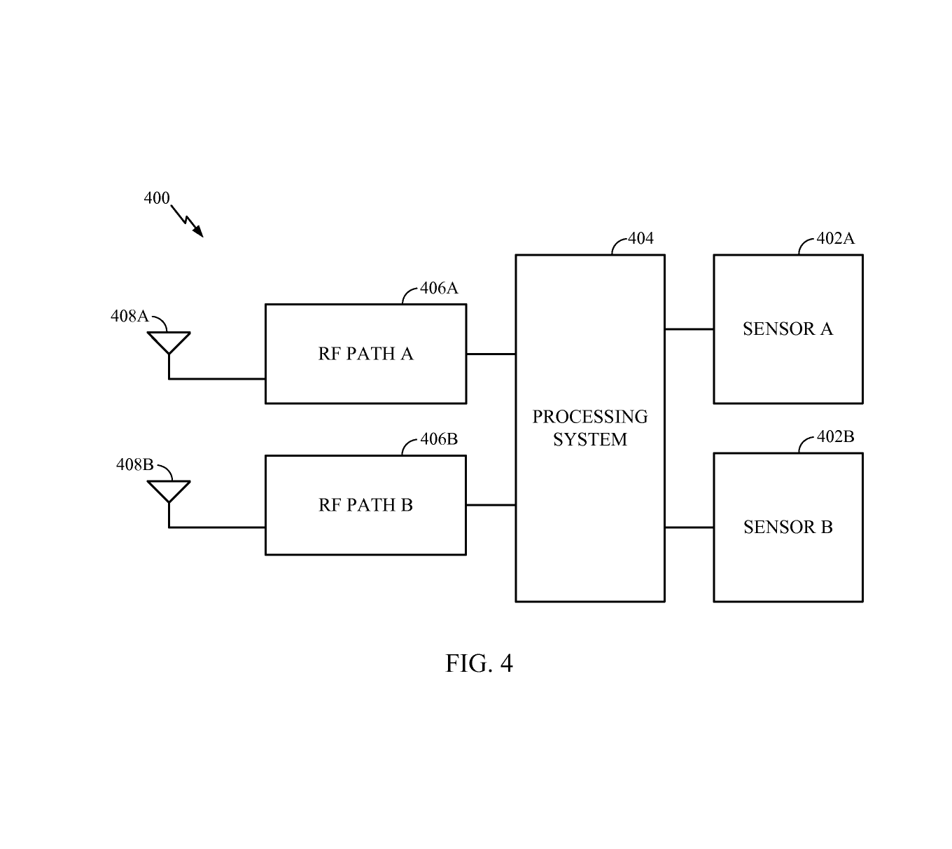

FIG. 4 is a block diagram of an example wireless device 400 having multiple sensors 402 and multiple RF paths 406 and capable of intelligently and individually enabling and disabling the RF paths. The wireless device 400 may be a user terminal 120, for example, and may have a processing system 404, which may include any combination of the processors described above with respect to FIG. 2. The RF paths 406 taken together may function similar to the transceiver front end 254 described above. Each of the RF paths 406 may include, for example, a low noise amplifier (LNA), an RF filter, a duplexer, a diplexer, a power amplifier (PA), a phase shifting stage for beam steering, a local oscillator (LO), a mixer, a voltage controlled oscillator (VCO), and the like. Each of the RF paths 406 may be associated with an antenna 408 for receiving and/or transmitting RF signals. The processing system 404 may be communicatively coupled to the RF paths 406. The wireless device 400 may also include proximity sensors 402 that provide sensed signals to the processing system 404. Similar to the proximity sensors 302 described above, each proximity sensor 402 may be positioned adjacent a corresponding antenna, on or near a surface of the wireless device 400.

The processing system 404 may be configured to process signals received from the antennas 408 via the RF paths 406 and from the proximity sensors 402. Based on calculations of a received signal level for each of the RF paths 406 and/or determinations of a signal blocking quantity from each of the proximity sensors 402 (e.g., a capacitance measured from a capacitive touch sensor), the processing system 404 may determine that one or more of the RF paths 406 should be disabled (e.g., powered off), such that these RF paths are no longer consuming current (e.g., from the battery (not shown) for the wireless device).

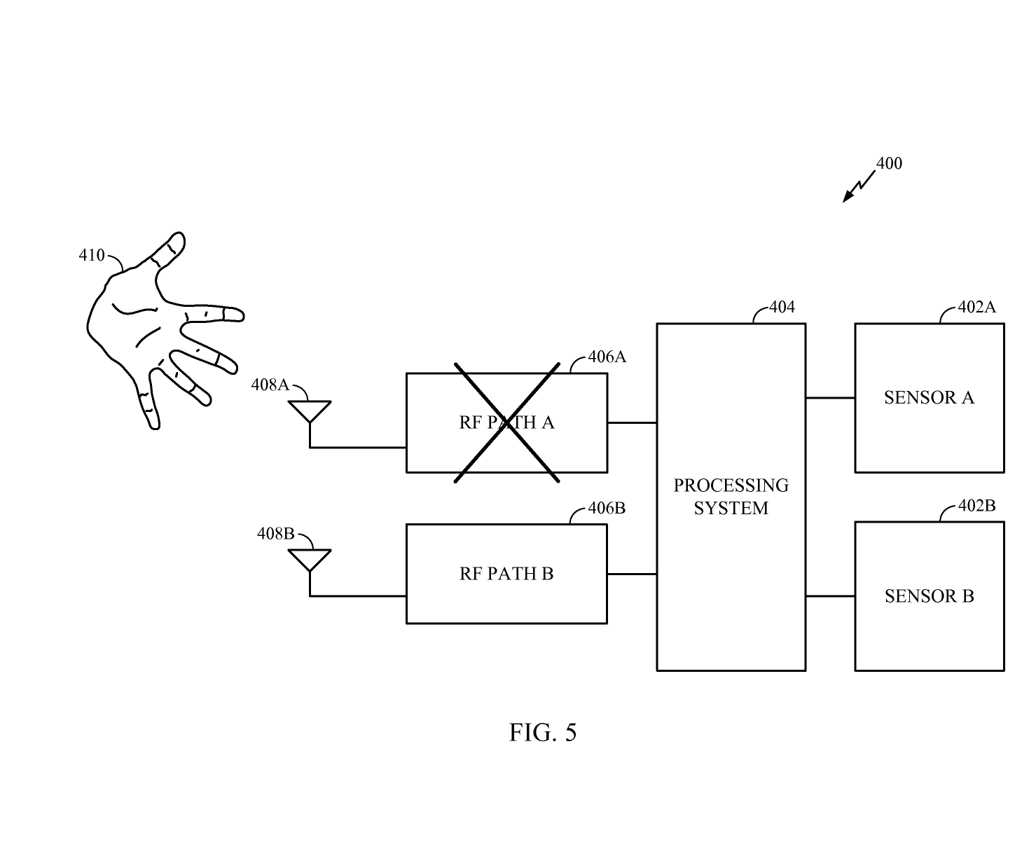

For example, FIG. 5 illustrates a user's hand 410 near enough to antenna 408A to reduce the received signal level of RF signals received by RF Path A 406A. The degradation in received signal level may be due to how the user is holding the wireless device 400, which may change over time as the user operates the device. The received signal level may also change due to signal strength in a given area, which may change as the user moves within a wireless communications network (e.g., closer to or further from an access point 110). If the received signal level decreases below a threshold (e.g., for a period greater than a predetermined amount of time), the processing system 404 may output one or more control signals that disable RF Path A (e.g., by removing power from active devices therein). This is conceptually illustrated by the “X” over RF Path A.

For certain aspects, the processing system 404 may use a combination of the received signal level for RF Path A (e.g., being below a threshold received signal level) and the signal blocking quantity as measured by Sensor A 402A (e.g., being above a particular value) in deciding whether to disable RF Path A. Any suitable mathematical and/or logical combination of these values may be used.

The user's hand 410 may not be close enough to (or cover enough of) antenna 408B to decrease the received signal level of RF signals received by RF Path B 406B below the threshold. Therefore, RF Path B may remain enabled, as shown in FIG. 5.

When an RF path is disabled, there is no way to measure received signal level for that particular RF path without enabling this path. However, perpetually enabling and disabling an RF path may waste power if a signal-blocking phenomenon is still present such that the RF path's received signal level remains below the threshold.

To solve this problem, certain aspects of the present disclosure use measurements from a proximity sensor associated with a disabled RF path to decide when to enable this RF path. If a signal blocking phenomenon changes (e.g., from a user repositioning his head or hand or discontinuing physical contact with the device), the processing system 404 may receive an altered signal from at least one of the proximity sensors. The signal blocking quantity may be compared to a threshold by the processing system 404. If the signal blocking quantity has been reduced below the threshold (e.g., due to the signal blocking phenomenon being removed altogether or repositioned), the processing system 404 may enable the appropriate previously-disabled RF path 406 (e.g., by outputting one or more control signals to provide power to the active devices in the RF paths). This is illustrated in FIG. 4, where both RF Paths A and B are enabled and the user's hand 410 has been removed, thereby reducing the signal blocking effect on antenna 408A.

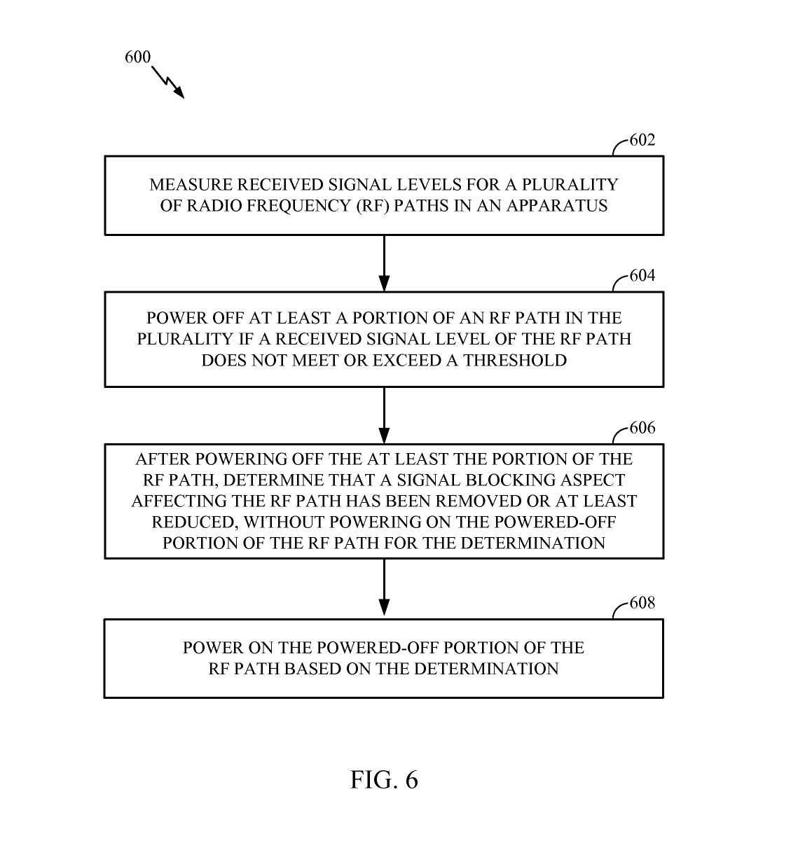

FIG. 6 is a flow diagram of example operations 600 for intelligently enabling or disabling one or more RF paths (i.e., RF chains) based on a received signal level and a sensor input. The operations 600 may be performed by an apparatus, such as a user terminal 120.

As illustrated in FIG. 6, the operations 600 may begin at 602, where the apparatus measures received signal levels for a plurality of radio frequency (RF) paths in the apparatus. The received signal levels may include at least one of a carrier-to-noise ratio (C/N) or a received signal strength indicator (RSSI), for example. At 604, the apparatus may power off at least a portion of an RF path in the plurality if a received signal level of the RF path does not meet or exceed a threshold. At 606, after powering off the at least the portion of the RF path, the apparatus may determine that a signal blocking aspect affecting the RF path has been removed or at least reduced. This determination is made without powering on the powered-off portion of the RF path. The signal blocking aspect may be an effect (e.g., hand-effect body loss) due to a head or a hand of a user of the apparatus, for example. At 608, the apparatus may power on the powered-off portion of the RF path based on the determination.

According to certain aspects, the determination at 606 may involve using one or more proximity sensors. The one or more proximity sensors may include one or more capacitive touch sensors. For certain aspects, each of the proximity sensors may be located adjacent an antenna for each of the plurality of RF paths. In this case, a first one of the proximity sensors may be located on a first surface of the apparatus, and a second one of the proximity sensors may be located on a second surface of the apparatus. The first surface may be opposite the second surface, for example. The signal blocking aspect degrades reception efficiency of the antenna for the RF path.

According to certain aspects, the operations 600 may further include the apparatus determining that the signal blocking aspect is above a level. In this case, the powering off at 604 may involve powering off the at least the portion of the RF path in the plurality if the received signal level of the RF path does not meet or exceed the threshold and if the signal blocking aspect meets or exceeds the level.

By having a proximity sensor associated with each of the antennas and/or RF paths, weighted combining (e.g., summing) of received signals for the RF paths may be performed, using the sensors and received signal levels for the RF paths. As used herein, weighted combining generally refers to a method for calculating the throughput and/or gain of signals received via the multiple antennas and RF paths (e.g., a primary and a secondary antenna/path).

In an ideal case where, for example, the wireless device has two equal RF paths and two equal gain antennas for the primary and secondary paths, the throughput data from the primary and secondary paths should be the same. Thus, the processing system can equally calculate the throughput data from the primary and secondary paths (e.g., apply no weighting or weight the paths equally).

Typically, however, a wireless device has a superior primary antenna (and/or RF path) and an inferior secondary antenna (and/or RF path). Therefore, according to certain aspects of the present disclosure, the processing system may apply different weights, which may be based on the received signal/throughput levels of the primary and secondary paths. In many cases, the primary antenna/path is weighted more than the secondary antenna/path. However, in certain scenarios (e.g., poor primary antenna condition due to the hand/body effect or damage to the primary path), the secondary antenna/path may be weighted more than the primary antenna/path. According to certain aspects of the present disclosure, the processing system may apply more weight to the secondary path, if the received signal level for the primary path is below a first threshold and/or if the signal blocking quantity for the primary path (as measured by the proximity sensor located adjacent the primary antenna) is above a second threshold.

According to certain aspects, the processing system may perform weighted combining (e.g., summing) using a matrix of received signal level and sensor signal inputs. The processing system may adjust the weight for each of the RF paths according to this matrix for an exact calculation.

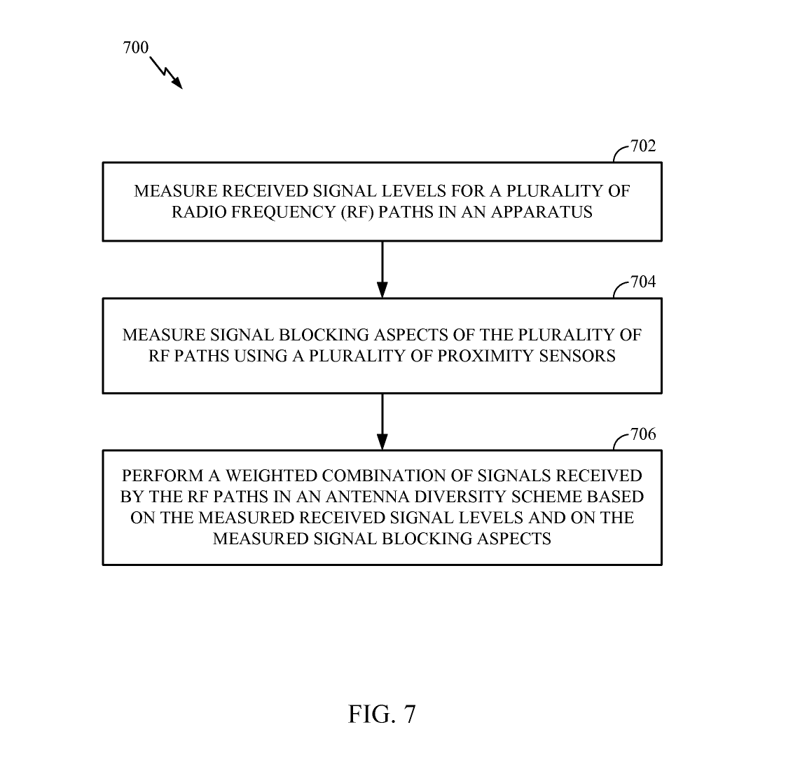

FIG. 7 is a flow diagram of example operations 700 for combining signals received by RF paths in an antenna diversity scheme, in accordance with certain aspects of the present disclosure. The operations 700 may be performed by an apparatus, such as a user terminal 120.

As illustrated in FIG. 7, the operations 700 may begin at 702, with the apparatus measuring received signal levels for a plurality of RF paths in the apparatus. For certain aspects, the received signal levels may include at least one of a carrier-to-noise ratio (C/N) or a received signal strength indicator (RSSI). At 704, the apparatus may measure signal blocking aspects of the plurality of RF paths using a plurality of proximity sensors. The signal blocking aspects may include effects due to a head or a hand of a user of the apparatus, for example. At 706, the apparatus performs a weighted combination of signals received by the plurality of RF paths in an antenna diversity scheme based on the measured received signal levels and on the measured signal blocking aspects.

According to certain aspects, the plurality of proximity sensors includes one or more capacitive touch sensors.

According to certain aspects, each of the proximity sensors is located adjacent an antenna in each of the plurality of RF paths. The signal blocking aspects may degrade reception efficiency of the antenna.

According to certain aspects, a first one of the proximity sensors may be located on a first surface of the apparatus, and a second one of the proximity sensors may be located on a second surface of the apparatus. For certain aspects, the second surface may be opposite the first surface.

The various operations or methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for transmitting may comprise a transmitter (e.g., the transceiver front end 254 of the user terminal 120 depicted in FIG. 2 or the transceiver front end 222 of the access point 110 shown in FIG. 2) and/or an antenna (e.g., the antennas 252ma through 252mu of the user terminal 120m portrayed in FIG. 2 or the antennas 224a through 224ap of the access point 110 illustrated in FIG. 2). Means for receiving may comprise a receiver (e.g., the transceiver front end 254 of the user terminal 120 depicted in FIG. 2 or the transceiver front end 222 of the access point 110 shown in FIG. 2) and/or an antenna (e.g., the antennas 252ma through 252mu of the user terminal 120m portrayed in FIG. 2 or the antennas 224a through 224ap of the access point 110 illustrated in FIG. 2). Means for processing, means for measuring, means for powering on, means for powering off, means for performing a weighted combination, or means for determining may comprise a processing system, which may include one or more processors, such as the RX data processor 270, the TX data processor 288, and/or the controller 280 of the user terminal 120 illustrated in FIG. 2. Means for measuring may comprise a sensor (e.g., proximity sensor 302) and/or a processing system for receiving signals from the sensor.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications, comprising:
measuring received signal levels for a plurality of radio frequency (RF) paths in an apparatus;
powering off at least a portion of an RF path in the plurality if a received signal level of the RF path does not meet or exceed a threshold;
after powering off the at least the portion of the RF path, determining that a signal blocking aspect affecting the RF path has been removed or at least reduced, without powering on the powered-off portion of the RF path for the determination; and
powering on the powered-off portion of the RF path based on the determination.

2. The method of claim 1, wherein the determining comprises using one or more proximity sensors.

3. The method of claim 2, wherein the one or more proximity sensors comprise one or more capacitive touch sensors.

4. The method of claim 2, wherein each of the proximity sensors is located adjacent an antenna for each of the plurality of RF paths.

5. The method of claim 4, wherein a first one of the proximity sensors is located on a first surface of the apparatus and wherein a second one of the proximity sensors is located on a second surface of the apparatus.

6. The method of claim 5, wherein the first surface is opposite the second surface.

7. The method of claim 4, wherein the signal blocking aspect degrades reception efficiency of the antenna for the RF path.

8. The method of claim 1, wherein the signal blocking aspect comprises an effect due to a head or a hand of a user of the apparatus.

9. The method of claim 1, further comprising:
determining that the signal blocking aspect is above a level, wherein the powering off comprises powering off the at least the portion of the RF path in the plurality if the received signal level of the RF path does not meet or exceed the threshold and if the signal blocking aspect meets or exceeds the level.

10. The method of claim 1, wherein the received signal levels comprise at least one of a carrier-to-noise ratio (C/N) or a received signal strength indicator (RSSI).

11. An apparatus for wireless communications, comprising:
a plurality of radio frequency (RF) paths; and
a processing system configured to:
measure received signal levels for the plurality of RF paths;
power off at least a portion of an RF path in the plurality if a received signal level of the RF path does not meet or exceed a threshold;
determine, after powering off the at least the portion of the RF path, that a signal blocking aspect affecting the RF path has been removed or at least reduced, without powering on the powered-off portion of the RF path for the determination; and
power on the powered-off portion of the RF path based on the determination.

12. The apparatus of claim 11, wherein the processing system is configured to determine that the signal blocking aspect has been removed or at least reduced by using one or more proximity sensors.

13. The apparatus of claim 12, wherein the one or more proximity sensors comprise one or more capacitive touch sensors.

14. The apparatus of claim 12, wherein each of the proximity sensors is located adjacent an antenna for each of the plurality of RF paths.

15. The apparatus of claim 14, wherein a first one of the proximity sensors is located on a first surface of the apparatus and wherein a second one of the proximity sensors is located on a second surface of the apparatus.

16. The apparatus of claim 15, wherein the first surface is opposite the second surface.

17. The apparatus of claim 14, wherein the signal blocking aspect degrades reception efficiency of the antenna for the RF path.

18. The apparatus of claim 11, wherein the signal blocking aspect comprises an effect due to a head or a hand of a user of the apparatus.

19. The apparatus of claim 11, wherein the processing system is further configured to determine that the signal blocking aspect is above a level and wherein the processing system is configured to power off the at least the portion of the RF path in the plurality if the received signal level of the RF path does not meet or exceed the threshold and if the signal blocking aspect meets or exceeds the level.

20. The apparatus of claim 11, wherein the received signal levels comprise at least one of a carrier-to-noise ratio (C/N) or a received signal strength indicator (RSSI).

21. A method for wireless communications, comprising:
measuring received signal levels for a plurality of radio frequency (RF) paths in an apparatus;
measuring signal blocking aspects of the plurality of RF paths using a plurality of proximity sensors; and
performing a weighted combination of signals received by the plurality of RF paths in an antenna diversity scheme based on the measured received signal levels and on the measured signal blocking aspects.

22. The method of claim 21, wherein the plurality of proximity sensors comprises one or more capacitive touch sensors.

23. The method of claim 21, wherein each of the proximity sensors is located adjacent an antenna in each of the plurality of RF paths.

24. The method of claim 21, wherein a first one of the proximity sensors is located on a first surface of the apparatus and wherein a second one of the proximity sensors is located on a second surface of the apparatus opposite the first surface.

25. The method of claim 21, wherein the signal blocking aspects comprise effects due to a head or a hand of a user of the apparatus.

26. An apparatus for wireless communications, comprising:
a plurality of radio frequency (RF) paths; and
a processing system configured to:
measure received signal levels for the plurality of RF paths;
measure signal blocking aspects of the plurality of RF paths using a plurality of proximity sensors; and
perform a weighted combination of signals received by the plurality of RF paths in an antenna diversity scheme based on the measured received signal levels and on the measured signal blocking aspects.

27. The apparatus of claim 26, wherein the plurality of proximity sensors comprises one or more capacitive touch sensors.

28. The apparatus of claim 26, wherein each of the proximity sensors is located adjacent an antenna for each of the plurality of RF paths.

29. The apparatus of claim 26, wherein a first one of the proximity sensors is located on a first surface of the apparatus and wherein a second one of the proximity sensors is located on a second surface of the apparatus opposite the first surface.

30. The apparatus of claim 26, wherein the signal blocking aspects comprise effects due to a head or a hand of a user of the apparatus.
